(19) United States
(12) Patent Application Publication
(10) Pub. No.: US 2002/0056826 A1
(43) Pub. Date: May 16, 2002

(54) Sanitary fluid handling controls

(76) Inventor: Joseph V. Tripoli, Kingwood, TX (US)

Correspondence Address: Valerie Friedrich, Suite 200, 1350 NASA Road One, Houston, TX, 77058, US

(21) Appl. No.: 09/990,786

(22) Filed: Nov. 14, 2001

Related U.S. Application Data
(60) Provisional application No. 60/249,135, filed on Nov. 16, 2000.

(51) Int. Cl. F16K 1/00

(52) U.S. Cl. 251/331

(57) ABSTRACT

Membrane sealed sanitary valves for use in processing and controlling fluid flow. The valve bodies are substantially straight through with no internal obstructions to flow and do not present stagnant flow regions. During use of the membrane sealed sanitary valves, the membrane does not stretch or abrade. The new valve body cavity and seat are formed by an infinite number of radii sealed laterally and decreasing in size from the top of the body cavity to the valve seat. The membrane of the present invention acquires, upon assembly, a 180° convolution which telescopes up and rolls in downward motion.

This invention claims priority under 35 USC 119(e) of the provisional application serial no. 60/249135, filing date Nov. 16, 2000.

### FIELD OF THE INVENTION

This invention relates to a novel membrane sealed valve for use in manufacturing processes. More particularly the present invention relates to an ultra-sanitary valve which provides several additional valve control functions and functional improvements over prior art diaphragm valves. More particularly, the invention relates to a novel membranes and novel valve body cavity and valve seat construction.

### BACKGROUND OF THE INVENTION

Fluid flow control valves are used in an extremely wide variety of manufacturing processes, including by way of example, the production of petrochemicals, the processing of foods, and the manufacture of pharmaceuticals. Certain prior art diaphragm valves have a relatively large flow coefficient, and therefore, are used by diverse industries as on/off valves. Such prior art diaphragm valves are also used in a variety of applications as sanitary valves and/or flow control valves despite the deficiencies, as discussed herein, of such diaphragm valves when used in such applications. There are two primary types of prior art diaphragm valves: (1) first, the varied height weir diaphragm valve in which the diaphragm is molded in the open position; and (2) second, the plug type diaphragm sealed valve (also called straight through valves) which has a plug in its diaphragm center area and in which the diaphragm is molded in the closed position. The diaphragms in each of the varied height weir type diaphragm valve and the plug type diaphragm valve must stretch about 10% in order to provide a fluid tight seal in the closed position.

One major difficulty with such prior art valves is the occurrence of contamination from fluids, by-products and derivatives of such fluids, and microorganisms which become trapped in or adhered to the valves. Such self contamination can result in the need for frequent shutdowns for cleaning operations in order to prevent the production of contaminated end products.

Plug type diaphragm sealed valve bodies generally include a small weir at the bottom center of the valve body and have an internal through-flow path which contains or encounters several obstructions, corners and crevices where contamination can occur. Consequently, plug type diaphragm sealed valves are not recommended for use as sanitary valves.

Furthermore, because the diaphragms of both the plug type diaphragm sealed and varied height type weir diaphragm valves must stretch to seal, stretch marks appear on the diaphragm following some use and such stretch marks create cracks and crevices which act as additional areas of contamination in both the varied height weir and plug type diaphragm valves. Diaphragm surface chafing upon metal stems also results in surface cracks and pores in the diaphragm. An additional source of contamination arises from the fact that neither the varied height weir nor plug type valves are self-draining when installed in a horizontal pipe, as is the conventional manner of installation.

Some weir diaphragm type valves employ a generally centrally-located lateral obstruction within their valve bodies, which are called weirs. Some of these obstructions to flow as in plug/weir type bodies are modest but others rise in height up to 65% or more above the valve inlet bottom. Such formidable obstructions to flow are necessary for all weir design diaphragm valves, because all such weir type valves employ large diameter short stroke diaphragms which seal over the wide top seating area of the weir. However, the vertical and lateral obstruction require several directional changes in the fluid flow, resulting in turbulent flow and in the formation of regions of stagnant flow, called eddys, at the base and side areas of the weir. Stagnant regions provide microorganism collection and growth areas, as well as sedimentation areas, which may be particularly harmful in sensitive laboratory biochemical, pharmaceutical, biotechnical and/or food applications.

Prior art valves are also deficient in numerous other aspects of their operation. Prior art diaphragm valves provide no flow control upon opening. For example, there is no flow control within about the first 10% (due to diaphragm stretch to seal). Therefore, to open, the stem must travel about 10% while the diaphragm is shrinking back into its vulcanized form. When the diaphragm recovers its original form and begins to pull away from the weir, the valve actually allows 40% to 70% of the total valve capacity to pass through the valve. It is this lack of sensitivity to small flow amounts which prevents prior art diaphragm valves from functioning as automatically controlled flow control valves. All automatic controllers modulate small amounts as required by the process and must provide the processing product with constant pressure, temperature and volume from their downstream side. When the automatic controller calls for minute amounts of fluid to be injected into the downstream product line but instead receives a large volume injected, that additional fluid causes the controller to slam shut. Such opening and slamming of the valve by the automatic controller is called hunting, causes product waste, and in most cases, is destructive to the controller and, in some cases, is destructive to the piping system. Further, these pressure spikes can cause diaphragm failure. The solution to this lack of sensitivity is the use of a fairly expensive device called a proportional positioner in conjunction with the diaphragm valve. In addition to positioners, it is common in industry to utilize a block valve following a diaphragm valve so as to assure positive closure and further protect against the surge of fluid through the diaphragm valve.

The prior art diaphragm type valves cannot easily be adapted for self contained relief valve services. This is due to the fact that the prior art valves require large diaphragms which are thick, hard, and non-flexible. The prior art valves require additional spring force to overcome the upward thrust of system pressure under the diaphragm, all of which would require disproportionately larger springs with heavier spring loads. Thereby making such adaptation not practical for general industrial or sanitary use. Even for first time relief pressure valve services, in which small amount release may be necessary. What is required are a gate and membrane which are vertical and occupy no more space than the poppet type valve and seat now employed in general and sanitary relief valve applications.

Bearing or burst strength of the diaphragm is effected by the amount of curvature. Greater curvature such as a true semicircle will withstand higher pressure for the same material thickness, the 180° semicircle at its bottom is the optimum. The effective area shift in some diaphragms is largest at either or both ends of the working stroke. As a consequence, the geometry of the cross section of some corrugated diaphragms will shift from a part of a semicircle configuration in its mean stroke position, to a substantially straight line flat diaphragm configuration at either the top or the bottom of the stroke, and the diaphragm wall causes substantial changes in effective working area.

In addition to the deficiencies in prior art diaphragm valves discussed above, there are a number of other problems with such prior art valves, including the following:

(a) No diaphragm can be described as dynamic; because all prior art diaphragms are thick, hard, nonflexible, and substantially static in their molded form, they are vulcanized into their particular shape, consisting of a center plug which is to seal against the lateral opening seating area, a horizontal area around the plug occupies a wide high corrugation above the rest of the body cavity, the rest of the diameter is extended to become a gasket between the valve top flange and the bottom flange of the top cap.

(b) No diaphragm can have a 1/64-inch total corrugation because the diaphragm has a large structural diameter and is stiff and resists operativeness and functions under difficult stressful conditions.

(c) No diaphragm is capable of having a constant semicircular bottom convolution because the diaphragm is not tubular; and can not function as a double seated tubular sealing device, the first end seals the valve body seat, then the tubular body of the vertical membrane is gradually enlarged to fill the substantially vertical body cavity with ample tolerance, the second end extremity is enlarged to provide a gasket for the body top flange and the top cap bottom flange.

(d) No diaphragm can seal against system pressure with constant pressure; because it must invert disfigure to move from open to closed; while doing so the force against system pressure will definitely vary.

(e) No diaphragm valve can provide system fluid in minute increments of flow; because the critical approximate first 10 percent of the valve opening is discounted; because it provides no flow at all; in spite of the fact that the first 10 percent of the valve opening is where the most crucial valve control area and where the most modulation takes place; and where small quantities of fluid maintain constant temperature, pressure, or volume in all instrument controlled process; therefore, the diaphragm valve is out of place as a control valve.

### SUMMARY OF THE INVENTION

Note that heretofore the terms “membrane” and “diaphragm” have often been used interchangeably by certain segments of industry. In the present application, the terms “diaphragm” and “membrane” are not used interchangeably. Rather, the term “diaphragm” is used to describe prior art devices and the term “membrane” is used in reference to the present invention.

The membrane sealed sanitary valve of the present invention utilizes a substantially tubular convoluted vertical membrane to control the process fluid and to separate the process fluids from the valve working parts. The present membrane sealed sanitary valves have substantially straight through and substantially full bore flow. The valve body cavity is formed by an infinite number of radii by which the valve seat can create different valve flow patterns. These patterns include precise linear proportional valve opening with equal proportional corresponding flow, producing a linear curve, to non-proportional flows also creating a linear curve plus fully characterized flows which can included in part as well within one valve, plus split range flows. The valve body inside top area below the flange is gently tapered inward and down toward the radii which converge and create the valve body seat.

The present invention eliminates the need for the positioner, since the present invention valves can be proportional, non-proportional, characterized or digital in accord with the controlling instrument requirements.

All diaphragm valves must have valve operators about twice the actual size necessary for the membrane sealed sanitary valve of the present invention because the diaphragm valve diaphragm is at least twice the diameter of the membrane seal; therefore, the valve operators require more thrust than membrane sealed valve operators. Furthermore, line pressure exerts upward thrust on all valves, which must be overcome by the valve operator; by comparison the prior art corrugated diaphragm presents about 90 percent or more of its surface to line pressure; the new semicircular convoluted membrane bottom presents 10 percent or less of its area to system pressure; therefore, the valve operators are smaller and less expensive.

Accordingly, it is an object of the present invention to provide membrane sealed valves of weirless type, substantially full bore with a series of new, useful engineering functions.

Another object of the present invention is to provide convoluted membrane valve seals.

Another object of the invention is to provide a valve body seating design, which will not create stagnant regions, or eddys, at its outlet side.

Another object of the invention is to provide internal valve body design which allows for truly sanitary valves over the life of the valve.

Another object of the invention is to stack and sequence various radiuses creating unique valve body seats for specific flow characteristics in accord with custom flow specifications.

Another object of the invention is to provide valve seals that do not substantially stretch nor need to stretch to create an effective seal.

Another object of the invention is to provide a valve body seat sealing device that retains a constant effective area in contact with system pipe pressure at all times.

Another object of the invention is to provide a valve body seat-sealing device whose stroke can be all vertical or all horizontal.

Another object of the invention is to provide body seat designs that are sealed by a dynamic sealing device.

Another object of the invention is to provide a series of useful valve body seat configurations for a series of different style valve bodies, which do not currently have the packless features such as; globe, poppet, plug, and check valve bodies, and others.

Another object of the invention is to provide a compatible convoluted membrane-sealing device to function in concert with the above mentioned valve body seats.

Another object of the invention is to provide a membrane seal with no preformed vulcanized convolution, and whose seating area will allow any seating design.

Another object of the invention is to provide a substantially full flow valve seal that does not significantly add to the valve operator force requirement by use of the reciprocating rolling convoluted membrane.

Another object of the invention is to provide valve operators that need not be oversized.

Another object of the invention is to provide a sanitary valve, whose sealing device need not be stretched, distorted and compressed at the same time in order to invert to close or open.

Another object of the invention is to provide a valve body seat which comprises a plurality of lateral opening radii which are designed to allow the valve body seat, the gate, and the membrane seal to act in concert to provide digital flow control.

Another object of the invention is to provide industry with a line of 150 psi and greater membrane sealed valves.

Another object of the invention is to provide a Teflon or plastic membrane which has no need for a second elastomer backup membrane.

Another object of the invention is to provide a double seated membrane sealed valve for large flows.

Another object of the invention is to provide multiple ported valves with direct and reverse acting convoluted membrane seals.

Another object of the invention is to provide membrane sealed manifold central process control stations with 16 or more ports, which act in concert with computer actuated controllers.

Another object of the invention is to provide prefabricated process controlled systems for field erection made from client predetermined dimensions and specifications. Process piping systems which will contain therein: stop valves, check valves, control valves for pressure, temperature and mixing valves etc., will be fabricated into a host pipe mill run length, thereby omitting a myriad of fittings such as elbows, tees, unions, and welding generally. For example, the elbows and tees are notorious for creating turbulence. The elbows would be replaced by smoothly lengthening the curve to reduce the turbulence of one 90° elbow by about 75%.

### BRIEF DESCRIPTION OF THE DRAWINGS

Figures are not to scale.

FIG. 1 is a side cross sectional view of a partially open valve with the membrane of the present invention.

FIG. 2 is a side cross sectional view of the valve body of the membrane sealed sanitary valve. The dashed lines indicate the membrane in the closed position.

FIG. 3 is a perspective view of the new valve body seat within a valve body illustrating the minute flow capability.

FIG. 4 is a side cross sectional view of a second preferred embodiment of the membrane sealed sanitary valve of the present invention used as a pressure relief valve. The dashed lines indicate the membrane in the closed position.

FIG. 5 is a percent of maximum valve opening versus percent of maximum flow graph showing the multiple possible flow patterns through the membrane sealed sanitary valve of the present invention.

FIG. 6 is a split side cross sectional view of the rolling unsupported convoluted membrane with the membrane in the open position shown on the right split section and the membrane in the closed position shown in the left split section.

FIG. 7 is a side cross sectional view of the membrane sealed sanitary valve showing the gate in full support of the membrane with detailed section.

FIG. 8 is a side cross sectional view of the membrane sealed sanitary valve showing the gate in full support of the membrane with detail for conversion.

FIG. 9 is a cross sectional side view of the membrane as molded for the valve body cavity shown in FIG. 3 for instrumentation and laboratory use.

FIG. 10 is a split side cross sectional view showing an open (right split section) and partially closed (left split section) convoluted membrane with stem and adjusting travel stop within the gate, adapted for compatible valve operator and computer actuated controller.

FIG. 11 is a partial side view of a membrane for small diameter size valve seats and miniaturized valves and for capillary flow.

FIG. 12 is a partial side view of a membrane for valve body seats compatible to FIG. 2.

FIG. 13 is a partial side view of a membrane for use with a globe or, poppet type valve seat.

FIG. 14 is a partial side view of a membrane seal for use as a vertical check valve.

FIG. 15 is a side view of a membrane of the present invention, gate and related valve components for use as a plug valve.

FIG. 16 is a side cross sectional view of a double seated, reverse acting membrane sealed valve of the present for industrial uses.

FIG. 17 is a side cross sectional view showing the convoluted membrane of the present invention in use in a globe valve body design with the valve in the open position.

FIG. 18 is a side cross sectional view showing the convoluted membrane of the present invention in use in a globe valve body design with the valve in the closed position.

FIG. 19 is a side cross sectional view of another embodiment of the valve of the present invention, being a 3-port valve that can be used as a blending valve and having, at the top of the outlet port, a sample port for testing specimens.

FIG. 20 is a side cross sectional view of a pressure-balanced four-ported valve, which can be used as a flow diverter with one inlet and two outlets and one direct and one reverse acting convoluted membrane seals.

FIG. 21 is a valve manifold consisting of two of the valves shown in FIG. 21.

### DETAILED DESCRIPTION OF THE INVENTION

Many of the elements of the valves with which the membrane of the present invention may be used are common elements found in prior art valves. Such elements include the following which are numbered identically in each figure:

1 Valve Stem

2 Top Cap

3 Stem Guide

4 Fasteners holding valve stem within stem guide

5 Internal Top Cap Guide

6 Valve Gate

7 Valve Body

9 Diaphragm Bolt

11 Parts Capsule Body

19 Travel Adjusting Nut

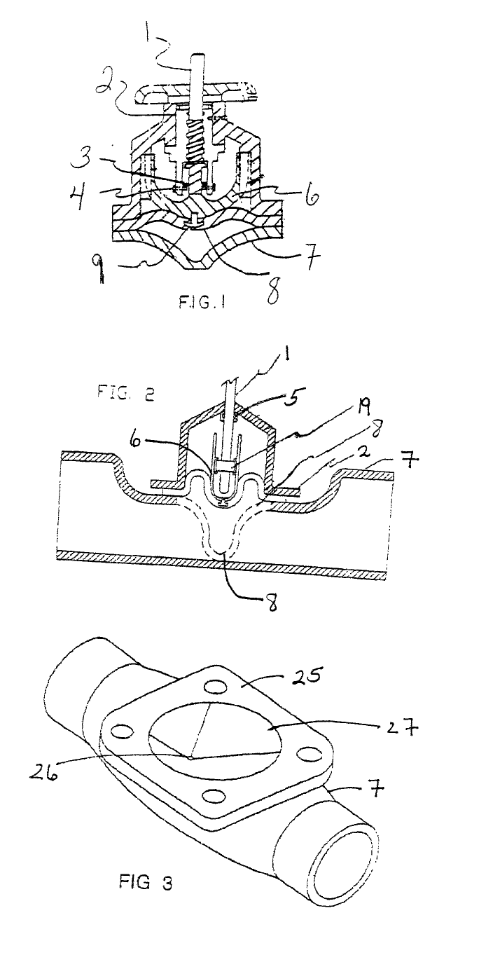

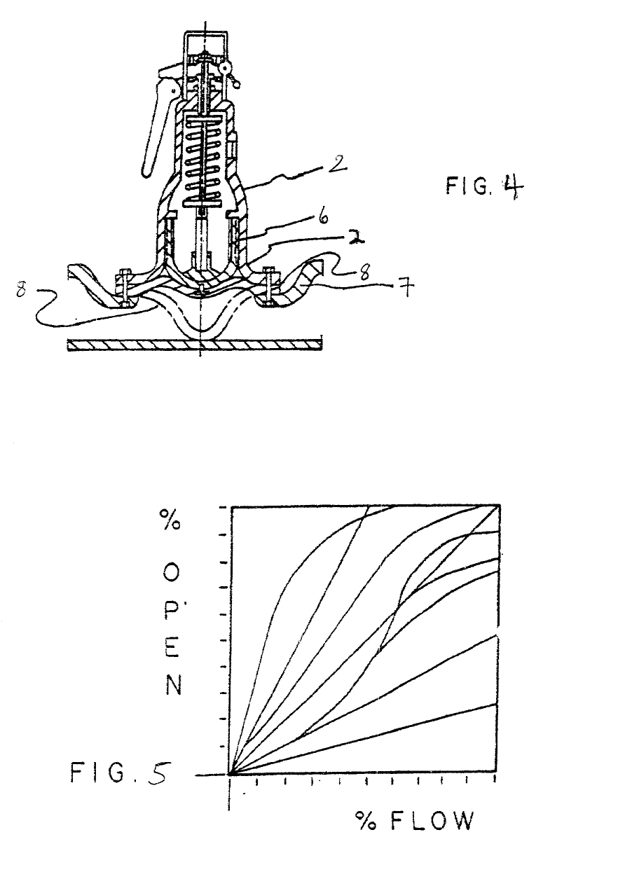

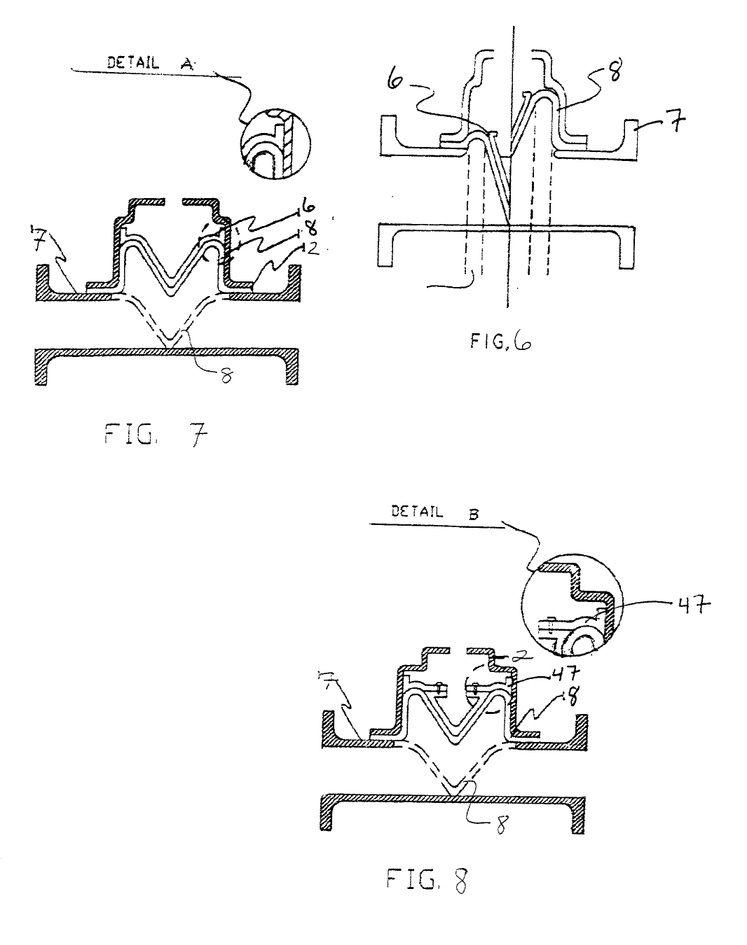

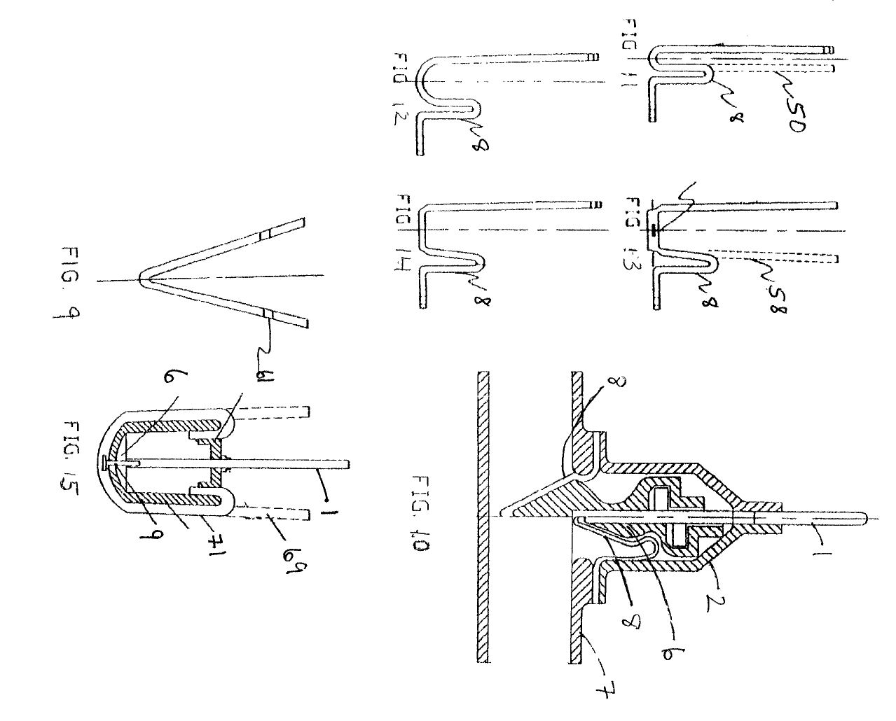

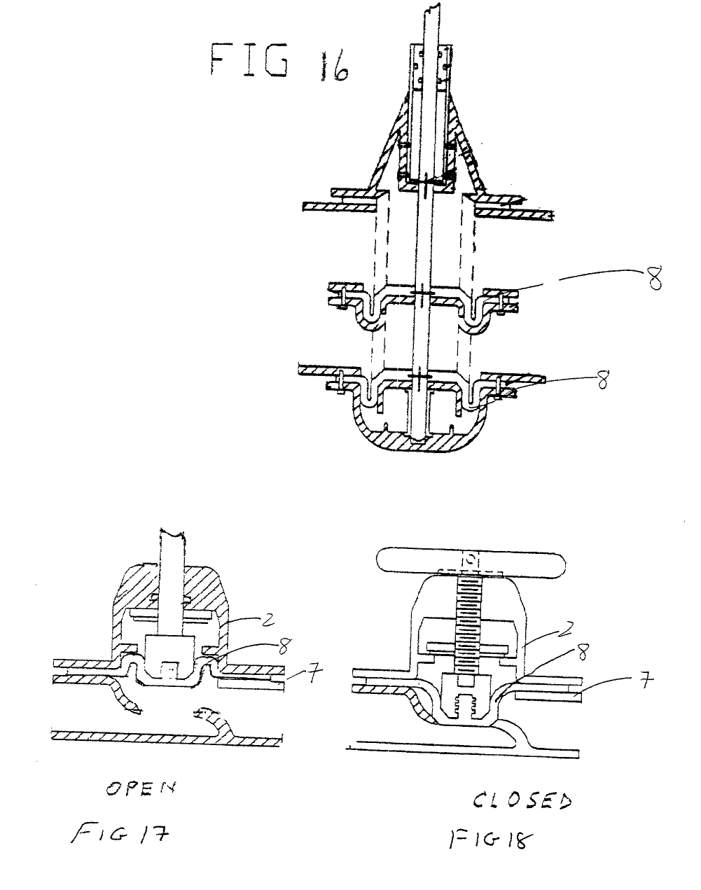

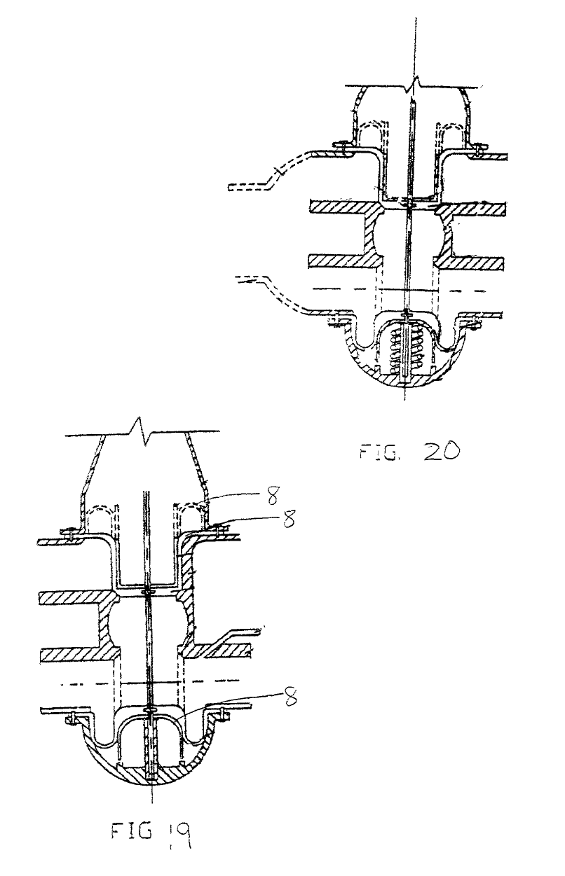

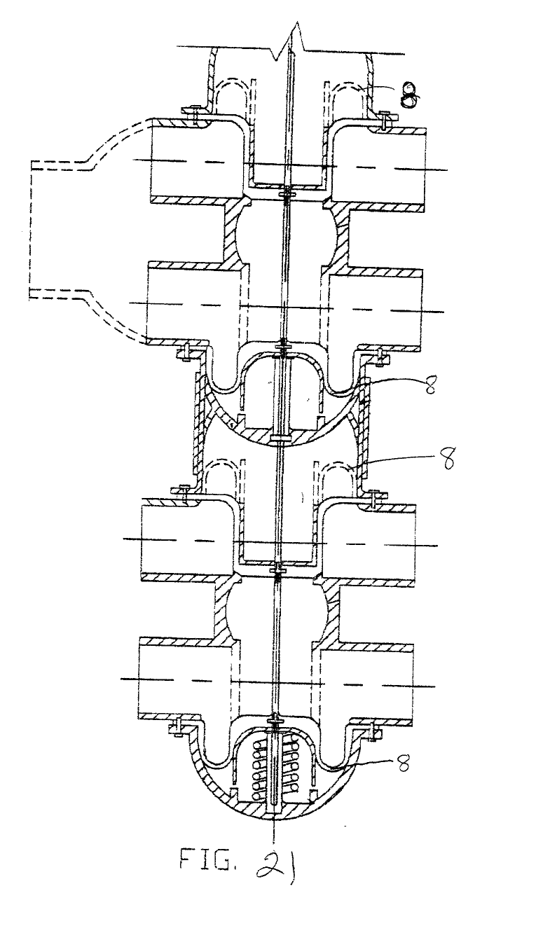

Referring first to FIG. 1, a sanitary gate control valve is shown in which the membrane 8 of the present invention is shown. As shown in FIG. 1, the diaphragm bolt 9 may also be used to attach the membrane 8 to the bottom portion of the valve gate 6. Referring now to FIG. 2, a sanitary valve in which membrane 8 is used is shown. The solid line 8 shows the membrane in the fully open position and the dashed line 8 shows the membrane in the fully closed position. Referring now to FIG. 3, a perspective view of the new valve body cavity and seat of the present invention is shown within the valve body. Note that the top cap, membrane, gate and valve stem are not shown in FIG. 3. Referring still to FIG. 3, the new valve body cavity consists of an infinite number of decreasing radii from the top of the body cavity 27 to the body seat 26. Top cap 2 (not shown) is attached to the valve body 24 at gasket 25. Referring now to FIG. 4, a side cross sectional view of a second preferred embodiment of the membrane sealed sanitary valve of the present invention is shown in which the valve is a pressure relief valve. The solid line 8 shows the membrane in the fully open position and the dashed line 8 shows the membrane in the fully closed position.

The features provided by the present membrane sealed sanitary valve are designed to broaden the general usage of membrane type sanitary gate control valves, plus sanitary relief valves. Further, features provided by the present invention are attained by the extremely simple and economical body designs plus fabrication method and application now not considered for sanitary gate control valves, sanitary relief or, any gate and membrane self-contained regulating type valves, because they all require modulation at the low volume end.

The above mentioned features are realized by the complete removal of all impediments, internal corners and crevices particularly from the valve body. The gate configuration is designed to coincide with the streamlined body inside diameter, and installed in the top cap juxtaposed above the molded membrane top margin perimeter seal. The gate has a cross sectional image of the new valve body seat which can be described as an infinite number of decreasing radii with allowances for its sealing the enveloping membrane. Upon manual downward thrust being applied by the valve stem, the gate and the membrane is forced down to the valve body seat thereby laterally restricting or closing fluid flow bubble tight.

The present invention provide a new valve body cavity construction consisting of an infinite number of radii, decreasing from the top of the valve body cavity to the body seat which provide a larger than inlet tubing size body cavity for equal inlet and outlet pipe sizes. The vertical extension of the radii of the valve body cavity permit one or more size outlet increases over inlet pipe size. In some control valve applications this is desirable where the object is to attain a velocity and pressure reduction of the product in the piping system prior to exit into a larger outlet pipe. The reverse is also feasible to do. The shape of the valve body cavity can be changed by adjustment of the body cavity height, and a venturi effect established to provide a higher fluid velocity through the valve rather than a diminished velocity if such additional velocity is beneficial to the process. The use of an infinite number of radii to form a valve body cavity permits a variety of design configurations, which provide various different and useful valve flow control characteristics and results, particularly when accompanied by a gate plus membrane construction that complements the valve body cavity and seat design. Furthermore, the valve body cavity and seat of the present invention permits self draining of all the valve bodies in any orientation thereby eliminating the use of a second valve to accomplish this need.

These valve body designs, for reasons of economy, are preferably fabricated from a short piece of sanitary seamless pipe or tubing, not used in any prior art. Seamless pipe or tubing are used here interchangeably. The selection of either is determined by the wall thickness, pressure rating, metal analyses, and internal diameter desired. Thereby, the fabricated valve body's inlet and outlet internal diameter will be identical to the pipe to which it is mated. Use of drawn seamless tubing would be less costly than a cast body and superior due to the absence of porosity found in castings and inclusions and internal blemishes found in forgings however, these are not excluded from use, final selection is dependent on cost and quality. A number of flow patterns achievable with the membrane sealed sanitary valve of the present invention are shown in FIG. 5.

The membrane 8 is dynamic thereby having minimal force requirements to open or close the valve. This dramatically increases the sensitivity of the control of the valve. This allows for much more exact control of fluid flows through the valve, even in very large valves.

Generally, the membrane 8 of the present invention is about one half of the diameter of a diaphragm of a prior art diaphragm valve of the same valve capacity.

The membrane 8 must have a full 180° convolution during translation in the valve open position. The membrane 8 rolls off the walls of the top cap inner diameter, and on to the gate outer diameter. This occurs on the opening cycle of the valve, the convolution is naturally reversible in motion and useable in any orientation.

Pressure bearing ability and travel strength is also effected by the amount of curvature in the membrane 8. The 180° curvature of membrane 8 will withstand higher pressure for the same material thickness compared to a diaphragm. When a membrane 8 is used with full support from the gate, the gate sustains the full line pressure as it supports the membrane 8.

The membrane 8 of the present invention may be constructed from any of a number of flexible and chemically resistant polymeric materials. In the preferred embodiment, the membrane 8 is constructed of a polyfluorocarbon material, such as Teflon.

By use of the above means, the present invention provides the sanitary valve user with accurate, repeatable control valve characteristics to meet the user's specific requirements, thereby eliminating the need for the positioner which must be used in conjunction with, and in-between the prior art on/off valve and the primary temperature, pressure and/or volume controlling instrument.

Referring now to FIG. 6, a split side cross sectional view of the rolling unsupported convoluted membrane is shown in which the membrane in the open position is shown on the right split section and the membrane in the closed position is shown in the left split section. As shown in FIG. 6, membrane 8 is not completely backed by the gate 6. In both FIGS. 7 & 8, membrane 8 is shown completely backed by gate 6. Refering now to FIG. 7 a membrane sealed sanitary valve showing the gate 6 in full support of the membrane 8 is shown with an enlarged detailed area of the gate backing the membrane. Referring now to FIG. 8, a standard gate valve is shown with conversion to a fully supported membrane 8 by attachment of a perimeter backing section 47 along the top rim of gate 6. The perimeter backing section 47 of the present invention permits field conversion of a gate valve to a fully supported membrane sealed sanitary valve of the present invention. Because each of FIGS. 6, 7 and 8 show a cross-sectional two-dimensional view of the valve and membrane, the full 180 degree semicircle at the bottom of the convolution of membrane 8 is not apparent.

Referring to FIG. 9 the membrane as molded for the valve body cavity shown in FIG. 3 for instrumentation and laboratory use is shown in its as molded shape. Bolt holes 61 permit membrane 8 to be attached between a top cap 2 and valve body 7 of a valve.

Each of FIGS. 11, 12, 13, and 14 show partial side cross-sectional views of the membrane of the present invention for use within different types of valves and for various valve applications. In each of these figures, only the left hand half portion of the membrane is shown. Again, because each of these figures are cross-sectional and two-dimensional, the full 180 degree convolution of the membrane is not apparent. In each of FIGS. 11, 12, 13, and 14, dashed line 50 shows the membrane in its as molded shape. Referring now to FIG. 11, the solid line describes the shape of membrane 8 in its open position as used for small diameter size valve seats and miniaturized valves and for capillary flow. In such valves, the seat of the valve is transposed to the sidewall of the seating surface resulting in minute, unmeasured capillary flow. Referring now to FIG. 12 membrane 8 for use with valve body seats compatible to those of FIG. 2 is shown. Referring now to FIG. 13 membrane 8 for use with a globe or, poppet type valve seat is shown. Bolt hole 56 provides a means for attaching the membrane between a top cap 2 and a valve body 7. Referring now to FIG. 14 membrane 8 for use as a vertical check valve is shown.

FIG. 15 illustrated a membrane 8 for use as a plug valve is shown. As shown in FIG. 15, the upper tubular portions 71 of membrane 8 is held in place between valve gate 6 and compression seal 75. Again, dotted line 69 shows the shape of membrane 8 as molded. Note that diaphragm bolt 9 may be used to hold membrane 8 onto valve stem 1 through the center of the bottom portion of gate 6. FIGS. 16 through 23 display a variety of applications for the membrane sealed valves of the present invention. FIG. 16 illustrates a double seated valve with two reverse acting membranes of the present invention. FIGS. 17 and 18 illustrate the use of the membrane of the present invention as used in a globe valve in the open and closed positions respectively. FIG. 19 illustrates a 3-port valve that can be used as a blending valve with a sampling port 120. FIG. 20 illustrates a pressure-balanced four-ported valve, which can be used as a flow diverter with one direct and one reverse acting convoluted membrane.

The versatility of the convoluted membrane sealed valve design illustrated in FIG. 20, has resulted in the design of FIG. 21 which is essentially two valve combination shown in FIG. 21 joined together to form an 8-port membrane sealed manifold, with both direct acting and reverse acting valve seals, different combination of flow control can be provided. The system of FIG. 21 is controlled by one or more valve stems.

This is only possible by the use of the dynamic, convoluted membrane and design of the valve of FIG. 20 being pressure balanced. There is no known reason why yet another connecting body cannot be used to expand these 8 ports to 16 ports, providing an even larger fluid manifold which would easily fit in a process control room with 1 or more valve operators and instruments for quick and easy valve adjustment from the instrument control room, saving valuable time and money, thereby eliminating the need to go to the process valve, a distance away, to make flow adjustments when needed.

A convoluted membrane seal defined by the following: the membrane sealed type valve is defined by the formula: when the convoluted membrane is not fully backed by the gate, the line pressure causes a force against the convolution which is 2TTDCP (DC=the top cap cylindrical diameter, C=convolution width, P=pressure in PSI considering only a unit of circumferential length force ft. lbs. Per inch in each side wall is F=PC; the tensile stress in the convolution must be equal to the side wall stress; therefore, the stress ST, PSI experienced by the side rolling membrane is ST=PC where T=thickness of the fabric;

Example: SF=Fabric stress (lbs. Per inch) PR=Applied pressure (PSI) C=Convolution (width in inches)

to determine membrane stress, the following formula is established, SF=PR×C example #1: if a 3.00 inch diameter side rolling membrane whose effective pressure area is 6.35 square inch and a small convolution width of 0.156″ is subjected to an applied pressure of 100 PSI, the resulting total thrust is 635 lbs., then the stress on the rolling convolution is as follows: SF=100×0.125=15.6 lbs. Per inch force on the convolution area; example #2: to determine the effective area of a rolling membrane, it may be compared directly with the equivalent pressure area of a frictionless leak proof piston; then the effective area of a rolling membrane is constant and will not shift or change its value with large changes in stroke; then, the effective area may be computed from the following equation:

AE=(DC-C)²×0.785

(Note) AE=Effective pressure area

DC=Cylinder bore

C=Convolution

The present formula allows a long stroke, a non-varying force against system pressure, a predetermined convolution width, a smaller diameter seal, and; a gate type valve comprising; a valve body; a reciprocating gate; a membrane to close an opening into the valve body; a space between an inside wall of the valve body and top cap and the gate seal rolling into the space in an open position.

This flow pattern is a primary design capability; providing minute increment of flow; and minute amounts of modulation; starting from a closed valve position and throughout the entire valve opening travel; the valve body will drain all process fluid, from any installed position; the above said establishes the valve design as unique.

The small convolution dimension of the membrane as illustrated; requires very little force and space with which to function; the second end is enlarged and its extremity extended to act as a gasket between the body top flange and the top cap bottom flange; thereby the tubular device seals from each end at two different body openings, working together for the same purpose; which is to create a sanitary membrane sealed, packless valve; which eliminates valve packing; as well as prevents valve body fluids from passing to other internal valve parts; because the tube is cut to any required length, the first end is sealed to comply with the design of the valve body seat and the valve gate and has unlimited reciprocating travel capability; and has no possibility to stretch during closing and opening to acquire chafing marks and surface blemishes and crevices on the membrane O.D.; thereby, insuring sanitation, within the valve body and its seat; the membrane and gate function in unison and in direct accord with each movement of the stem, operator, and controlling instrument no matter how minute; the equal proportional flow valve body seat opening with equal proportional valve stem travel provide the straight line proportional curve; therefore, there is no reason to purchase the otherwise required proportional positioner for the process control system circuit; the proportional positioner has been replaced by the valve body seat design with its compatible gate and seal; therefore, the prior art valves are not cost effective.

I claim:

1. A membrane sealed sanitary valve comprising:
a valve body having a top flanged opening and a valve body seat;
a top cap attached to said top flanged opening and having a parts capsule removably attached inside said top cap, said parts capsule comprising:
a valve stem;
at least one stem vertical guide;
at least one bearing surface responsive to said stem vertical guide;
at least one seal designed to seal an internal pressure area of said valve from ambient conditions outside said valve, wherein said valve stem protrudes beyond said top cap and is designed to reciprocate and accommodate an operator;
a valve gate attached to said stem and responsive to movement of said stem and;
a telescoping membrane seal responsive to movement of said gate having a substantially semicircular reversing convolution, wherein said gate is designed to move said membrane seal against said valve body seat to intersect a flow passageway through said valve body without substantial stretching of said membrane seal by telescoping along an axis aligned with said movement of said gate.

2. A telescoping membrane seal comprising:
a tubular piece of material having a first end and a second end, said first end being closed and said second end being substantially open.

3. The membrane sealed sanitary valve of claim 1 wherein said telescoping membrane seal comprises:
a tubular piece of material having a first end and a second end, said first end being closed and said second end being substantially open and wherein said first end is movably attachable to said valve gate and wherein said telescoping membrane seal comprises an inner surface, an outer surface, and sides and wherein an upper portion of said sides fits between said top cap and said valve body of said membrane sealed sanitary valve and wherein said first end forms a reversing convolution responsive to the movement of said gate.

4. The membrane sealed sanitary valve of claim 1 wherein the movement of said telescoping membrane seal in response to gate produces a straight linear proportional flow pattern.

5. The membrane sealed sanitary valve of claim 1 wherein the movement of said telescoping membrane seal in response to gate produces a non-linear characterized flow pattern.

6. The membrane sealed sanitary valve of claim 1 wherein the movement of said telescoping membrane seal in response to gate produces a non-proportional linear flow pattern.

7. The membrane sealed sanitary valve of claim 1 further comprising a pressure activated relief port.

8. The membrane sealed sanitary valve of claim 1 wherein said valve body seat comprises a parabolic shaped center area and wherein the shape of said gate substantially complements said parabolic shaped center area.

9. The membrane sealed sanitary valve of claim 1 wherein said valve body seat comprises a plurality of lateral radiuses with progressively increasing radii from a bottommost radii to a topmost radii.

10. The membrane sealed sanitary valve of claim 9 further comprising a digital flow controller electrically and mechanically connected to said gate.
